(19) United States
(12) Patent Application Publication
(10) Pub. No.: US 2010/0321471 A1
(43) Pub. Date: Dec. 23, 2010

(54) METHOD AND SYSTEM FOR PERFORMING IMAGING

(76) Inventor: Mark CASOLARA, Manassas, VA (US)

Correspondence Address: ARENT FOX LLP, 1050 CONNECTICUT AVENUE, N.W., SUITE 400, WASHINGTON, DC, 20036, US

(21) Appl. No.: 12/820,749

(22) Filed: Jun. 22, 2010

Related U.S. Application Data
(60) Provisional application No. 61/219,235, filed on Jun. 22, 2009.

(51) Int. Cl. H04N 5/225

(52) U.S. Cl. 348/36; 348/218.1; 348/207.1; 348/E05.024

(57) ABSTRACT

Apparatus and methods for performing multi-degree imaging are disclosed including capturing images via a number of lenses, wherein the captured images cover a field of view. In addition, the apparatus and methods include combining the captured images to produce a single image stream and displaying the image stream, where extraneous information between the captured images is removed.

### RELATED APPLICATIONS

The present application claims priority to Provisional Application No. 61/219,235 entitled “360 Degree Persistent Sensor” filed Jun. 22, 2009, the entirety of which is expressly incorporated by reference herein.

### BACKGROUND OF THE INVENTION

1. Field of the Invention

The present invention relates to methods and apparatus relating to imaging systems using optical sensors. In particular, the present invention relates to imaging systems using optical sensors for viewing three hundred and sixty (360) degree images.

2. Background of the Related Art

Related art imaging systems that are capable of viewing a 360 degree image typically use six or more cameras with multiple lenses to capture the field of view. These systems require multiple people to operate and review the images captured from the various cameras. In addition, these systems require the stitching of images together from the various cameras to produce a 360 degree field of view. The image stitching process may lead to significant processing time since the sensors may have moved (e.g., in pitch and yaw) during the stitching process or the scene may have changed (e.g., objects moving in and out of the field of view). If the sensors move and/or the scene changes during the image stitching process, data can be lost from the images captured by the cameras, resulting in an incomplete picture. For example, the lost data may occur in the upper portion of the image and/or the lower portion of the image, as illustrated in FIG. 7A.

Other related art imaging systems rotate a camera around to capture a 360 degree field of view. Generally, these systems need to be rotated at a constant velocity and stopped at the proper place in order to capture a good frame. The movement of the camera in these systems creates noise and jitter in the image, which must be removed during the image processing. For example, a periscope on a submarine is typically rotated around during a window of time in order to capture a 360 degree field of view. During the time it takes to rotate the periscope around 360 degrees, if the ship rocks and/or objects move in or out of the image, the image processing will try to reconcile these changes (e.g., changes in pitch, yaw, depth, course and speed) to the scene and data may be lost. Thus, the processing time is increased and the image produced is not always a clear representation of the field of view.

Other related art imaging systems use a fish eye lens (e.g., a spherical or concave lens) which bends the captured light to bring in a wider field of view. These systems typically introduce distortion into the image since they are projecting a flat surface onto a curved surface causing the edges of the image to be bent. Thus, the image produced is a distorted image and not a clear representation of the field of view, as illustrated in FIG. 7B.

Related art imaging systems also typically require power for either the sensors' rotation or camera operation. Having a power source near the image produced may cause electromagnetic interference (EMI) signatures which can be detected in the image. Further, having the power source in the sensors increases the size of the sensors.

Thus, there is a need in the art for an optical sensor capable of capturing a complete image stream from a 360 degree field of view, while resolving the power, processing and distortion issues in currently available imaging systems.

### SUMMARY OF THE INVENTION

While discussion of the aspects of the present invention that follows uses sensory imagery for submarines and unmanned under water vehicles for an illustrative purpose, it should be appreciated that aspects of the present invention are not limited to sensory imagery for submarines, and may be used in a variety of other environments. For example, aspects of the present invention may be used for perimeter surveillance, surveillance for security or anti-terrorism activities, surveillance for harbor and port security, military applications, littoral surveillance, providing situational awareness, underwater sensor imagery, intelligence gathering, or any other environment where a user may need to view a 360 degree image.

Aspects of the present invention include a sensor system for aiding a user in viewing a 360 degree field of view. The sensor system may combine images from multiple lenses covering a 360 degree field of view and transferring the combined images to a camera. The camera may produce a single video stream, instead of the multiple separate video streams from the lenses, displaying the whole 360 degree field of view. Thus, real time data monitoring of a 360 degree field of view is possible. In addition, instead of having the image split between multiple monitors, the image is capable of being produced in a single image. Moreover, since the image is captured by a camera simultaneously from each individual lens, data is not lost during the processing of the images and the image is clear, without distortions. While discussion of the aspects of the present invention relates to 360 degree imagery, other configurations are feasible that represent other fields of view of less than 360 degrees (e.g., 180 degrees or 90 degrees).

In one aspect of the present invention miniature lenses, e.g., less than one half inch in diameter, with focal lengths similar to the human eye, are used to capture the image. Using miniature lenses allows the optical sensor to weigh less and be adaptable to varying mission profile requirements (e.g., placing the optical sensor on a building or using the sensor in a ship).

### BRIEF DESCRIPTION OF THE DRAWINGS

The present invention will become fully understood from the detailed description given herein below and the accompanying drawings, which are given by way of illustration and example only and thus not limited with respect to aspects of the present invention, wherein:

FIG. 1 illustrates an exemplary system diagram in accordance with aspects of the present invention;

FIG. 2 illustrates example optical sensor used in with an aspect of the present invention;

FIG. 3 illustrates an exemplary system diagram in accordance with another aspect of the present invention;

FIG. 4 is an example image produced in accordance with aspects of the present invention;

FIG. 5 is an example of the focus capability of a lens used with an aspect of the present invention;

FIG. 6 is an exemplary flow diagram of functions performed in accordance with aspects of the present invention;

FIGS. 7A and 7B illustrates examples of lost image data and image distortion;

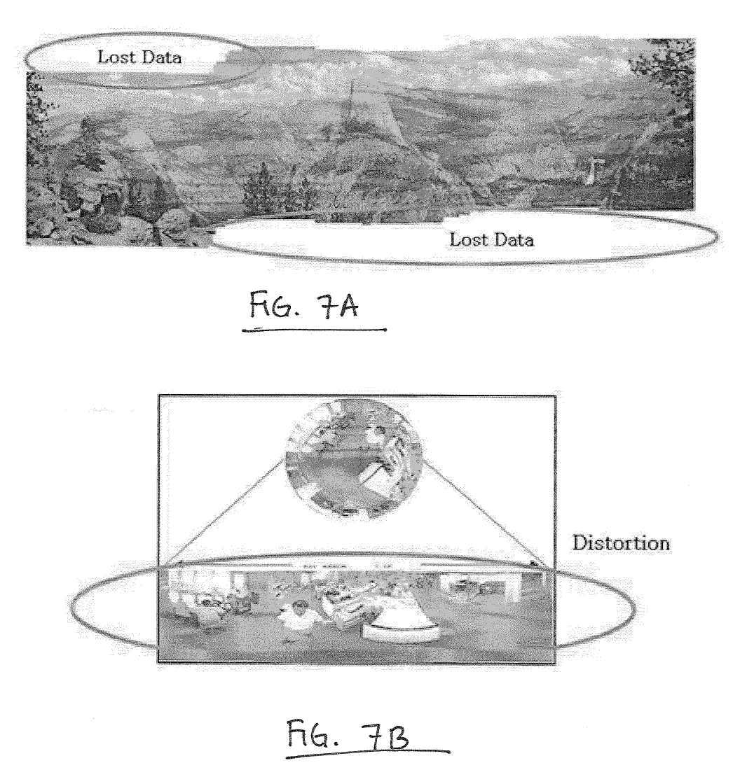

FIG. 8 illustrates various features of an example computer system for use in conjunction with aspects of the present invention; and

FIG. 9 illustrates an exemplary system diagram of various hardware components and other features, in accordance with aspects of the present invention.

### DETAILED DESCRIPTION OF ASPECTS OF THE PRESENT INVENTION

Aspects of the present invention will now be described more fully hereinafter with reference to the accompanying drawings, in which variations of aspects of the present invention are shown. Aspects of the present invention may, however, be realized in many different forms and should not be construed as limited to the variations set forth herein; rather, the variations are provided so that this disclosure will be thorough and complete in the illustrative implementations, and will fully convey the scope thereof to those skilled in the art.

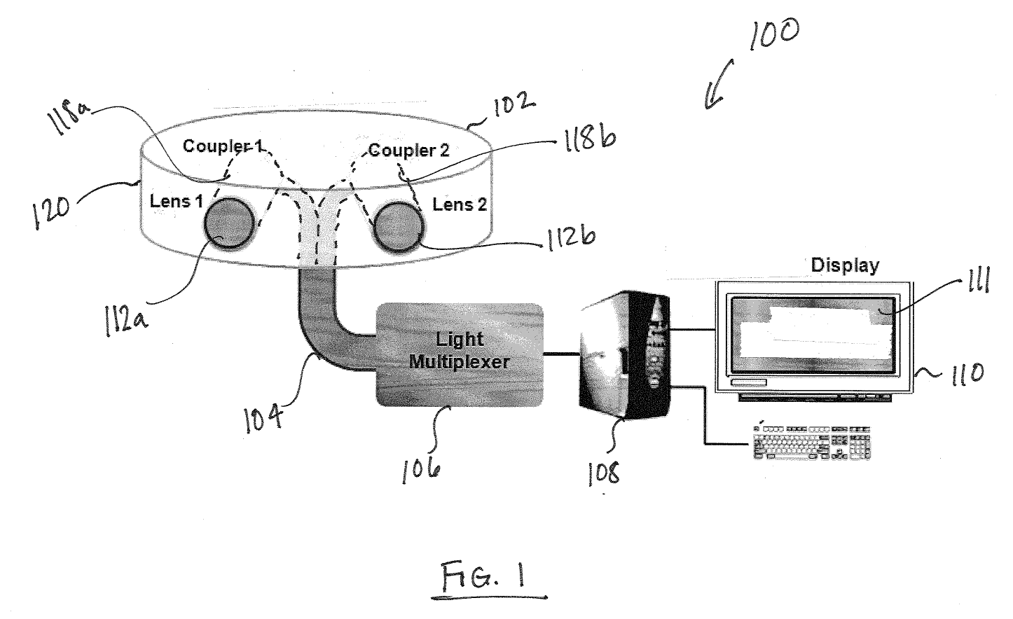

Turning now to FIG. 1, illustrated is an example system 100 for performing imaging in accordance with an aspect of the present invention. The system 100 includes an optical sensor 102 that captures images from a number of lenses 112a, 112b and displays a combined image 111 on a display 110. The system 100 also includes a switch 106 and a processor 108 that assist in transforming and/or transferring the captured images from the optical sensor 102 into the combined image 111.

In an aspect, an optical sensor 102 may include a number of lenses 112a, 112b positioned within the optical sensor 102 that are operable for capturing an image covering a field of view. The field of view may be, for example, a three hundred and sixty (360) degree field of view or a one hundred and eighty (180) degree field of view, among other fields of view. The number of lenses within the optical sensor may be dependent on the field of view, e.g., three lenses may be necessary for capturing a 180 degree field of view, while six lenses may be necessary for capturing a 360 degree field of view. It should be appreciated that any number of lenses may be used in the optical sensor, as long as the area captured by the lenses covers the desired field of view without blank spots and/or blind spots in the captured image. Thus, the image may be achieved without having to move and/or rotate the lenses since the lenses are positioned in the optical sensor so they cover the full field of view, e.g., the entire 180 degrees or 360 degrees.

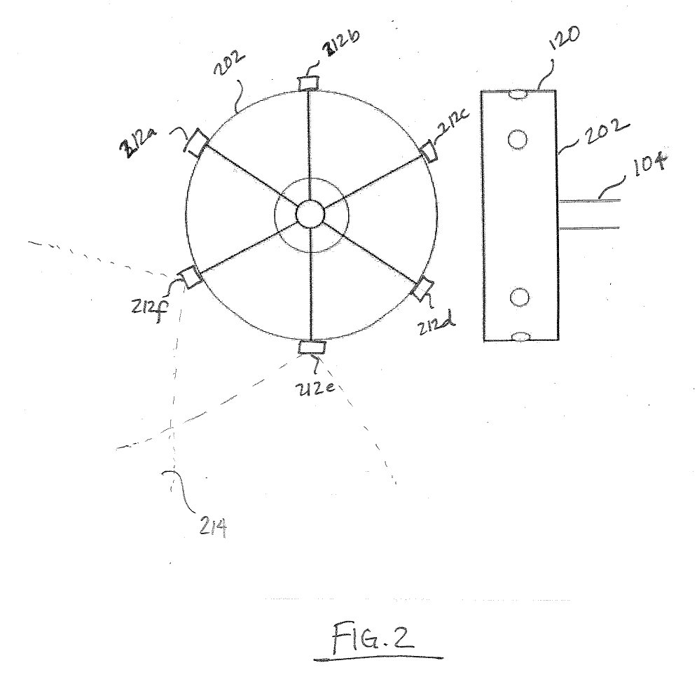

Referring now to FIG. 2, illustrated is an example optical sensor 202 that may be used with an aspect of the present invention for capturing a 360 degree field of view. The optical sensor 202 may be in a shape of a circular array comprising six lenses 212a-f. The lenses 212a-f may be positioned, for example, in a circle sixty degrees apart with the front portions of the lenses 212a-f directed outwards towards the image and/or the scene being captured. In addition, the lenses 212a-f may be positioned, for example, perpendicular to the ground providing a horizontal view of the surrounding area and/or at any angle provided the lenses are capable of capturing the desired area. Thus, a 360 degree image may be achieved without having to move and/or rotate the lenses since the lenses are positioned in the optical sensor so they cover the full 360 degrees. It should be appreciated that the optical sensor may be any shape as long as the lenses enclosed within the optical sensor cover the desired field of view to be captured (e.g., 360 degrees).

Referring back to FIG. 1, in an aspect, the lenses 112a, 112b may be interfaced to a fiber optic cable 104 (or other transmission medium, such as copper wire) via a coupler 118a, 118b. The coupler 118a, 118b may connect the lenses 112a, 112b together and/or transmit the captured images from the lenses 112a, 112b to the switch 106. In addition, coupling the lenses 112a, 112b together may create an enclosure 120. The size of enclosure 120 may be proportional to the size of the lenses 112a, 112b. For example, the enclosure 120 may be the size of a hockey puck, e.g., the width of the enclosure may be 2 inches, and the diameter of the enclosure may be 4 inches. Thus, capturing a 360 degree field of view may be possible with a small lens package, e.g., enclosure 120. It should be appreciated that lenses of other sizes may be accommodated by the enclosure using appropriate relay lenses to focus the image.

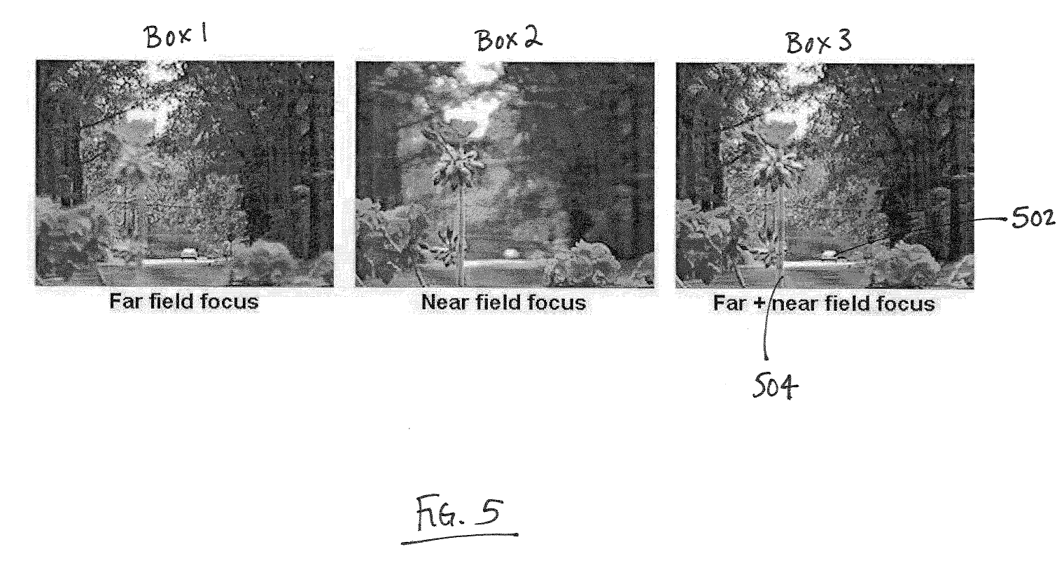

Additionally, the lenses 112a, 122b in the optical sensor 102 may be miniature lenses, e.g., less than one half inch in diameter, having focal properties approaching that of the human eye. Boxes 1 and 2 of FIG. 5 illustrate the focal properties of current optical systems, i.e., they are either focused in the far field with near items out of focus, as shown in Box 1 or in the near field, with far items out of focus, as shown in Box 2. As illustrated in FIG. 5, Box 3, lenses 112a, 112b are capable of focusing on a distant object 502 while everything in the near field of view 504 also remains in focus. For example, the lenses may be Constant Focus™ lenses. Thus, the focal length of lenses 112a, 122b may have focal properties approaching those of the human eye.

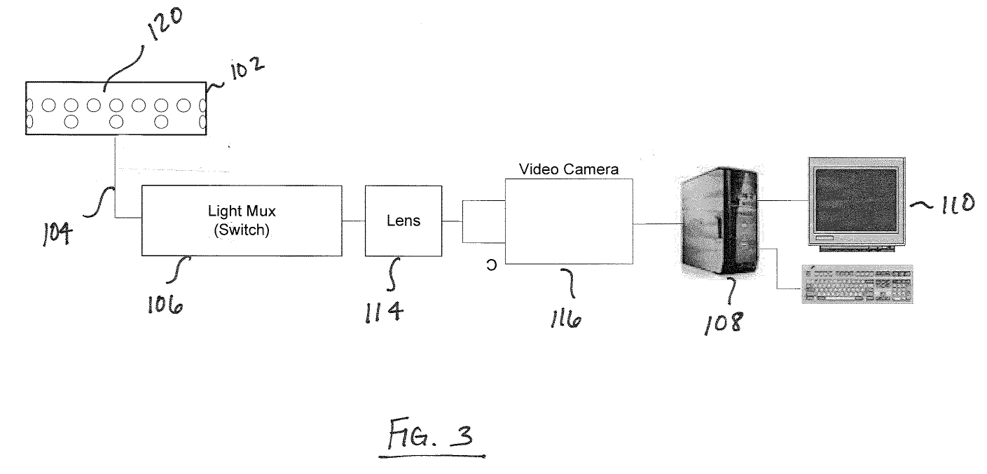

Referring back to FIG. 1, the optical sensor 102 is operationally connected to the switch 106, via a transmission medium 104, e.g., a fiber optic cable and/or any medium capable of transferring the captured image from the lenses to the switch. The switch 106 may be, but is not limited to, a light multiplexer, a fiber optic cable, a series of Charge Coupled Devices (CCD) that multiplex the imagery, and/or any device capable of switching and magnifying the incoming light. In an aspect, switch 106 may be operationally connected to a processor 108. The processor 108 may remove image overlap between the captured images, if applicable, and may display a combined image 111 on a display 110 operationally connected to the processor 108. In another aspect, the switch 106 may be operationally connected to a lens, which may be operationally connected to a camera, as illustrated in FIG. 3. It should be appreciated that optical sensor 102, switch 106 and processor 108 may be operationally connected via fiber optic cable or any material capable of transferring the captured image from the lenses to the switch and the processor.

Referring now to FIG. 3, illustrated is an aspect of the system in which the switch 106 is operationally connected to a lens 114. In operation, for example, a 360 degree image is captured by the lenses 212a-f (FIG. 2). The image from the lenses 212a-f is transferred via the fiber optic cable 104 or other media to a switch 106, e.g., a light multiplexer, for switching and magnifying the incoming fiber optic signal through a lens 114. The output image of lens 114 is set to an appropriate size so that the image fully cover the charge coupled device (CCD) of the camera 116 operationally connected to the lens 114. By switching the light multiplexer 106 at 30 Hz, each lens's image is captured five times per second. In an alternative aspect, the output of the light multiplexer 106 is connected directly to the CCD of the camera 116. The light multiplexer 106 may arrange the captured images into a line in an order (e.g., each lens may be associated with a number 1 through 6). The order may include, for example, the images being placed from left to right starting with a 1 and ending with a 6. Each frame is essentially already “stitched,” e.g., correctly aligned with a next frame, since there has been no significant movement of the platform between captures. For example, if each lens in the optical sensor 102 is placed 60 degrees apart and has a 68 degree field of view, as illustrated in FIG. 2, there would be an overlapping field of view 214 between the lenses since each lens covers a wider area than the angles between each two lenses.

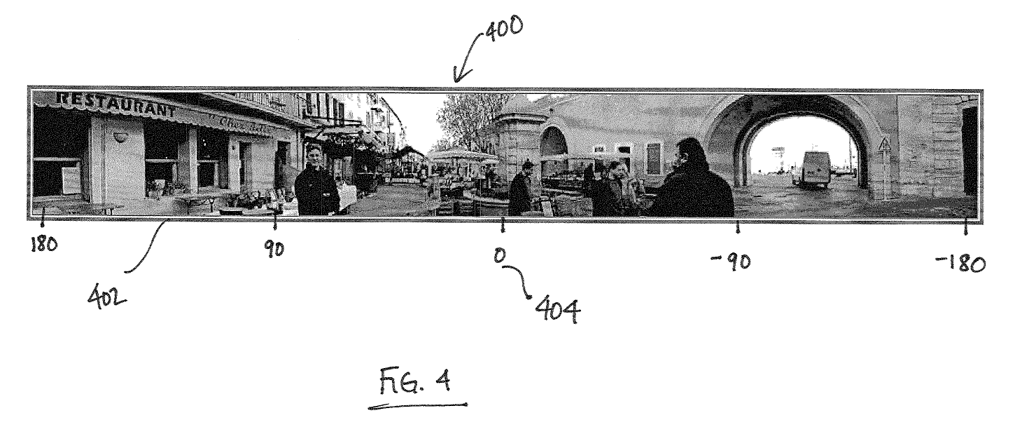

Referring again to FIG. 3, the camera 116 receives the “stitched” image from the light multiplexer 106 and sends, at, e.g., 30 frames per second, a single image stream comprising the “stitched” image to the processing system 108. The camera 116 may be connected to the processing system 108, for example, via wire, network cable, fiber optic cable, or a wireless connection, among other connections. The processing system 108 may remove the image overlap and displays the “stitched” 360 degree image comprising the images captured from the individual lenses as a single output on the display 110, as illustrated in FIG. 4. Thus, instead of a still frame of 360 degree images, the system is capable of providing a real-time or near real-time 360 degree streaming video with a coherent image of the field of view.

Referring now to FIG. 4, illustrated is an example image 400 outputted on display 110 (FIG. 1). In the illustrated example, the image 400 displayed shows a 360 degree field of view captured from six lenses (212a-f in FIG. 2), each with a 60 degree field. An axis 402 runs along the bottom of the image 400 indicating the direction of the image from a center point 404.

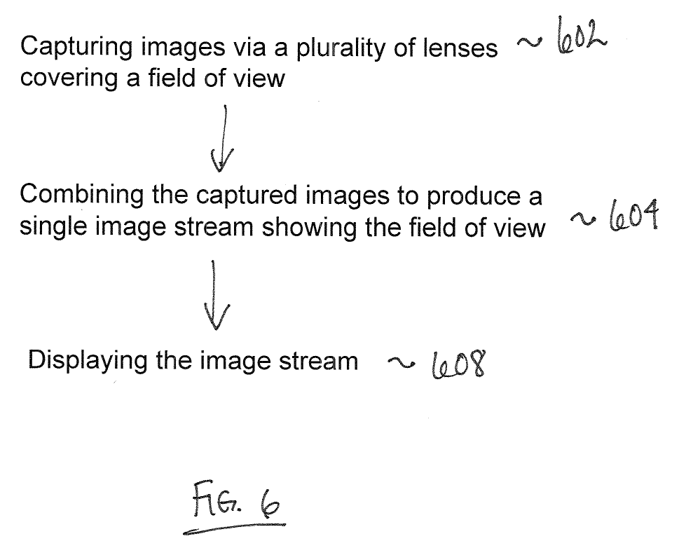

Referring now to FIG. 6, illustrated is an exemplary flow diagram 600 of functions performed in accordance with aspects of the present invention. The method may include capturing an image covering a field of view via a number of lenses at 602. It should be appreciated that the number of lenses used to capture an image may be determined based upon the field of view of each lens and the desired field of view to be captured without blank spots and/or blind spots in the captured image. For example, six lenses with a sixty-eight degree field of view may be arranged such that the six lenses cover a 360 degree field of view. In addition, it should be appreciated that the images captured by the respective lenses are captured contemporaneously (e.g., in near real time), thus reducing the effects of motion on the image.

Next, the method may include combining the images captured to produce a single image stream 604. The images from each lens may be combined via a light multiplexer (e.g., a fiber optic cable or other transmission device), to produce a real-time or near real-time streaming video of the field of view. For example, a single image may be reconstructed from the images provided by the different lenses (e.g., stitching the images together). That is, a single 360 degree image may be reconstructed from six different lenses capturing the entire 360 degrees. The images may be placed in order based upon a number associated with each lens. For example, each of the six lenses may be associated with a numbered (e.g., from 1 to 6) with the images being placed in an order from left to right starting with a 1 and ending with a 6, among other possible orders. During the stitching process redundant information may be removed from the image stream from the overlapping fields of view.

The method may further include displaying the single image on a display 608. For example, the single image may be displayed in a line, e.g., a rectangle, with the images in order from left to right displaying the entire 360 degrees.

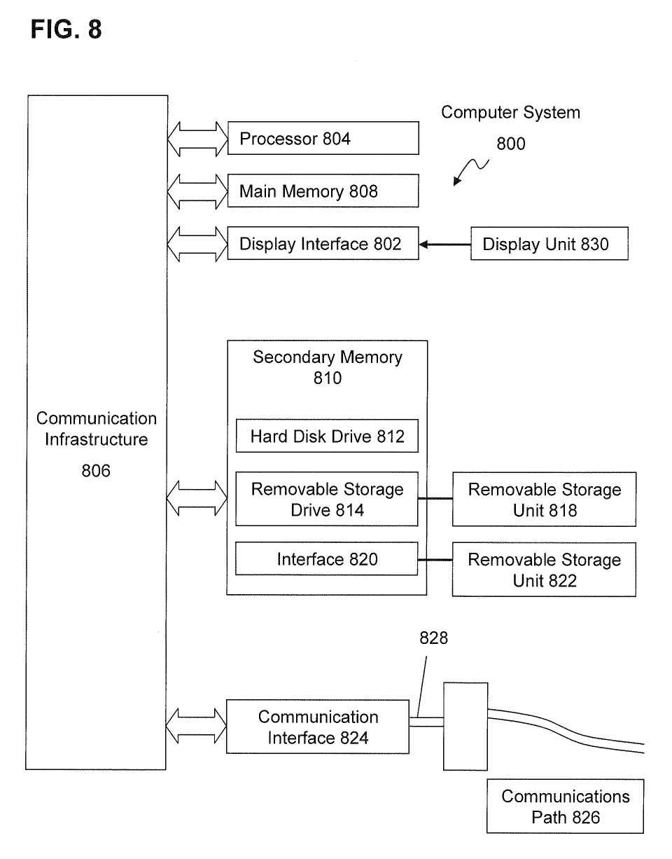

The present invention may be implemented using hardware, software or a combination thereof and may be implemented in one or more computer systems or other processing systems. In one aspect, the invention is directed toward one or more computer systems capable of carrying out the functionality described herein. An example of such a computer system 800 is shown in FIG. 8.

Computer system 800 includes one or more processors, such as processor 804. The processor 804 is connected to a communication infrastructure 806 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 800 can include a display interface 802 that forwards graphics, text, and other data from the communication infrastructure 806 (or from a frame buffer not shown) for display on the display unit 830. Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well known manner. Removable storage unit 818, represents a floppy disk, magnetic tape, optical disk, etc., which is read by and written to removable storage drive 814. As will be appreciated, the removable storage unit 818 includes a computer usable storage medium having stored therein computer software and/or data.

In alternative aspects, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket, and other removable storage units 822 and interfaces 820, which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824 are in the form of signals 828, which may be electronic, electromagnetic, optical or other signals capable of being received by communications interface 824. These signals 828 are provided to communications interface 824 via a communications path (e.g., channel) 826. This path 826 carries signals 828 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 814, a hard disk installed in hard disk drive 812, and signals 828. These computer program products provide software to the computer system 800. The invention is directed to such computer program products.

Computer programs (also referred to as computer control logic) are stored in main memory 808 and/or secondary memory 810. Computer programs may also be received via communications interface 824. Such computer programs, when executed, enable the computer system 800 to perform the features of the present invention, as discussed herein. In particular, the computer programs, when executed, enable the processor 804 to perform the features of the present invention. Accordingly, such computer programs represent controllers of the computer system 800.

In an aspect where the invention is implemented using software, the software may be stored in a computer program product and loaded into computer system 800 using removable storage drive 814, hard drive 812, or communications interface 824. The control logic (software), when executed by the processor 804, causes the processor 804 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

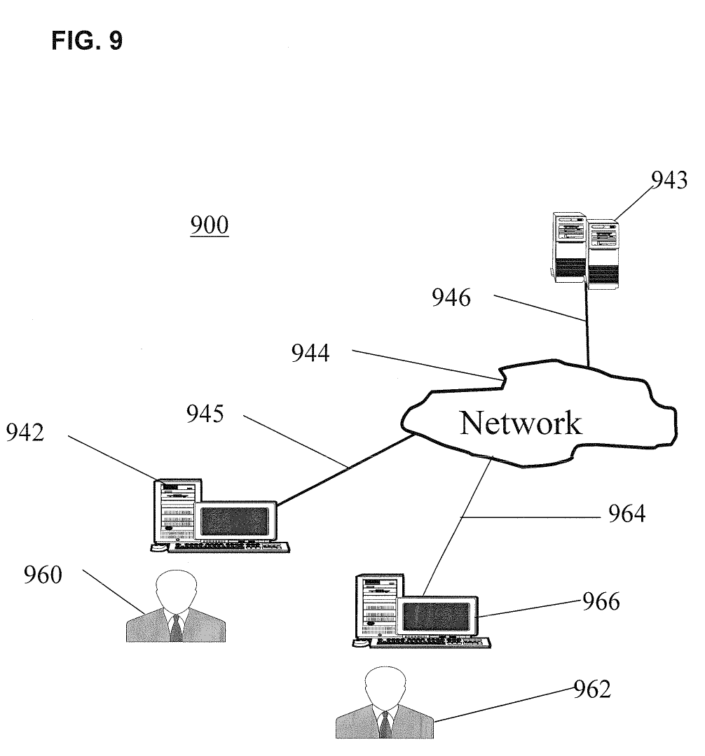

FIG. 9 shows a communication system 900 usable in accordance with the present invention. The communication system 900 includes one or more accessors 960, 962 (also referred to interchangeably herein as one or more “users”) and one or more terminals 942, 966. In one aspect of the present invention, data for use is, for example, input and/or accessed by accessors 960, 964 via terminals 942, 966, such as personal computers (PCs), minicomputers, mainframe computers, microcomputers, telephonic devices, or wireless devices, such as personal digital assistants (“PDAs”) or a hand-held wireless devices coupled to a server 943, such as a PC, minicomputer, mainframe computer, microcomputer, or other device having a processor and a repository for data and/or connection to a repository for data, via, for example, a network 944, such as the Internet or an intranet, and couplings 945, 946, 964. The couplings 945, 946, 964 include, for example, wired, wireless, or fiber optic links. In another aspect of the present invention, the method and system of the present invention operate in a stand-alone environment, such as on a single terminal.

While the present invention has been described in connection with various aspects of the present invention, it will be understood by those skilled in the art that variations and modifications of the aspects of the present invention described above may be made without departing from the scope of the invention. Other aspects will be apparent to those skilled in the art from a consideration of the specification or from a practice of the invention disclosed herein.

1. An apparatus for performing multi-degree imaging, the apparatus comprising:
an optical sensor configured to capture images via a plurality of lenses, wherein the captured images cover a field of view;
a switch coupled to the optical sensor configured to combine the captured images to produce a single image stream showing the field of view;
a display coupled to the switch configured to display the single image stream.

2. The apparatus of claim 1, wherein a number of lenses in the plurality of lenses is based upon a size of the field of view.

3. The apparatus of claim 2, wherein the number of lenses is two or six.

4. The apparatus of claim 2, wherein when the number of lenses is three, the size of the field of view is one hundred and eighty degrees, and when the number of lenses is six, the size of the field of view is three hundred and sixty degrees.

5. The apparatus of claim 1, wherein the switch is further configured to arrange the captured images in a predefined order.

6. The apparatus of claim 5, wherein the order is based on a number associated with each of the plurality of lenses.

7. The apparatus of claim 1, further comprising:
a processor coupled to the switch and the display, wherein the processor is configured to remove image overlap between the captured images.

8. The apparatus of claim 1, wherein the image stream provides a near real time streaming video of the field of view.

9. The apparatus of claim 1, wherein each of the plurality of lenses is placed in a specific location based upon the field of view.

10. The apparatus of claim 1, wherein the switch is further configured to magnify the captured images.

11. The apparatus of claim 10, wherein the switch operates at thirty hertz (Hz).

12. The apparatus of claim 1, further comprising:
a lens coupled to the switch operable to receive the single image stream; and
a camera coupled to the lens, wherein the output from the lens covers a charge coupled device (CCD) of the camera.

13. A method for performing multi-degree imaging, the method comprising:
capturing images via a plurality of lenses, wherein the captured images cover a field of view;
combining the captured images to produce a single image stream showing the field of view; and
displaying the image stream.

14. The method of claim 13, wherein a number of lenses in the plurality of lenses is based upon a size of the field of view.

15. The method of claim 14, wherein the number of lenses is three or six.

16. The method of claim 14, wherein when the number of lenses is three, the size of the field of view is one hundred and eighty degrees, and when the number of lenses is six, the size of the field of view is three hundred and sixty degrees.

17. The method of claim 13, further comprising arranging the captured images in a predefined order.

18. The method of claim 17, wherein the order is based on a number associated with each of the plurality of lenses.

19. The method of claim 13, further comprising removing image overlap between the captured images.

20. The method of claim 13, wherein the image stream provides a near real time streaming video of the field of view.

21. An apparatus for performing multi-degree imaging, the apparatus comprising:
a module for capturing images via a plurality of lenses, wherein the captured images cover a field of view;
a module for combining the captured images to produce a single image stream showing the field of view; and
a module for displaying the image stream.

22. A computer product comprising a computer readable medium having control logic stored therein for causing a computer to perform multi-degree imaging, the control logic comprising:
first computer readable program code means for capturing images via a plurality of lenses, wherein the captured images cover a field of view;
second computer readable program code means for combining the captured images to produce a single image stream showing the field of view; and
third computer readable program code means for displaying the image stream.
